(19) United States
(12) Patent Application Publication
(10) Pub. No.: US 2024/0214133 A1
(43) Pub. Date: Jun. 27, 2024

(54) TRANSMISSION CONFIGURATION INDICATOR STATE APPLICABILITY PRIOR TO ACKNOWLEDGEMENT

(71) Applicant: QUALCOMM Incorporated, San Diego, CA (US)

(72) Inventors: Fang YUAN, Beijing (CN); Yan ZHOU, San Diego, CA (US); Jelena DAMNJANOVIC, Del Mar, CA (US); Tao LUO, San Diego, CA (US)

(21) Appl. No.: 18/553,105

(22) PCT Filed: May 25, 2021
(86) PCT No.: PCT/CN2021/095695

§ 371 Date: Sep. 28, 2023

(51) Int. Cl. H04L 1/1867; H04L 5/00

(52) U.S. Cl. CPC H04L 1/1887; H04L 1/1896; H04L 5/0094

(57) ABSTRACT

Certain aspects of the present disclosure provide techniques for communicating using a target transmission configuration indicator (TCI) state associated with a dynamically received target TCI prior to transmitting an acknowledgement for the target TCI. An example method performed by a user equipment (UE) includes receiving a target transmission configuration indicator associated with a target transmission configuration indicator state and one or more target channels and communicating one or more transmissions via a first target channel of the one or more target channels prior to transmitting signaling acknowledging the target transmission configuration indicator. Based on whether at least one criterion is satisfied or not, the UE may either use the target transmission configuration indicator state or a default transmission configuration indicator state when communicating the one or more transmissions.

### INTRODUCTION

Aspects of the present disclosure relate to wireless communications, and more particularly, to techniques for communicating using a target transmission configuration indicator (TCI) state associated with a target TCI prior to acknowledgement of the target TCI.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

Certain aspects can be implemented in a method for wireless communication performed by a base station (BS). The method generally includes transmitting a target transmission configuration indicator associated with a target transmission configuration indicator state and one or more target channels and communicating one or more transmissions via a first target channel of the one or more target channels prior to receiving signaling acknowledging the target transmission configuration indicator. In some cases, communicating the one or more transmissions via the first target channel includes communicating the one or more transmissions via the first target channel using the target transmission configuration indicator state when at least one criterion is satisfied. Additionally, in some cases, communicating the one or more transmissions via the first target channel includes communicating the one or more transmissions via the first target channel using a default transmission configuration indicator state associated with a default transmission indicator when the at least one criterion is not satisfied.

Certain aspects can be implemented in a method for wireless communication performed by a user equipment (UE). The method generally includes receiving a target transmission configuration indicator associated with a target transmission configuration indicator state and one or more target channels and communicating one or more transmissions via a first target channel of the one or more target channels prior to transmitting signaling acknowledging the target transmission configuration indicator. In some cases, communicating the one or more transmissions via the first target channel includes communicating the one or more transmissions via the first target channel using the target transmission configuration indicator state when at least one criterion is satisfied. Additionally, in some cases, communicating the one or more transmissions via the first target channel includes communicating the one or more transmissions via the first target channel using a default transmission configuration indicator state associated with a default transmission indicator when the at least one criterion is not satisfied.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIG. 4A is a process flow illustrating dynamic TCI configuration and use of an associated TCI state for Fifth Generation New Radio Release 16.

FIG. 4B is a process flow illustrating dynamic TCI configuration and use of an associated TCI state for Fifth Generation New Radio Release 17.

FIG. 5 is a call flow diagram illustrating example operations for communicating using a target transmission configuration indicator state associated with a target transmission configuration indicator prior to acknowledgement of the target transmission configuration indicator.

FIGS. 6 and 7 illustrate example process flows for communicating using a target transmission configuration indicator state prior to acknowledgement of an associated target transmission configuration indicator for different types of target channels.

FIG. 8 illustrates an example process flow for communicating using a dynamically configured TCI state prior to acknowledgement of an associated dynamically received TCI for multi-beam operation

FIG. 9 is a flow diagram illustrating example operations for wireless communication by a base station.

FIG. 10 is a flow diagram illustrating example operations for wireless communication by a user equipment.

FIGS. 11 and 12 depict aspects of example communications devices.

### DETAILED DESCRIPTION

Aspects of the present disclosure provide apparatuses, methods, processing systems, and computer-readable mediums for communicating using a target transmission configuration indicator (TCI) state associated with a target TCI prior to acknowledgement of the target TCI.

In some cases, the user equipment (UE) may be configured with a set of beam indications for communicating in one or more bandwidth parts. The beam indication sets may be transmission configuration indicator (TCI) states, which may indicate a beam that should be used for transmitting or receiving a particular transmission. In some cases, the set of beam indications, or TCI states, may be configured for a particular channel or type of transmission. Different types of TCI states exist, such as single channel TCI states, which apply only to a single target channel, and multi-channel TCI states, which apply to multiple target channels. In some cases, a TCI state may be configured by a target transmission configuration indicator received in a downlink control information (DCI) message.

In certain wireless communications standards, when the UE receives a target TCI in a DCI message from a base station, the UE may be required to transmit acknowledgement information that acknowledges whether the UE received the target TCI. In certain cases, there may be a significant time delay between reception of the target TCI and transmission of the acknowledgement information for the target TCI. Within this time delay, the UE may be scheduled to communicate one or more transmissions via one or more target channels to which the target TCI applies. However, because the UE is required to transmit acknowledgement information for the target DCI, it is unclear whether the UE may use a target TCI state associated with the target TCI to communicate the one or more transmissions via the one or more target channels prior to transmitting acknowledgement information for the target TCI.

For example, if the UE is not able to use the target TCI state associated with the target TCI to communicate (e.g., transmit or receive) transmissions on the target channel, there may be significant latency in switching beams (e.g., indicated by the target TCI state) for communicating the one or more transmissions. Such latency in switching beams may lead to the UE communicating the transmissions using sub-optimal beams, resulting in dropped transmissions. Retransmission may then need to be performed by either the base station or the UE, which unnecessarily consumes power and processing resources at the base station and UE, as well as time and frequency resources within a wireless communication network.

Thus, aspects of the present disclosure provide techniques for communicating using a target TCI state associated with a dynamically received target TCI prior to acknowledging reception of the TCI. In some cases, such communication may be based on whether at least one criterion is satisfied. For example, a wireless communication device, such as a base station or a user equipment, may communicate one or more transmissions via a target channel using a target TCI state associated with the target TCI when at least one criterion is satisfied while the wireless communication device may communicate the one or more transmissions via the target channel using a default TCI state associated with a default TCI when the at least one criterion is not satisfied. When the at least one criterion is satisfied and the UE is able to use the target TCI state to communicate the one or more transmissions, the latency associated with a beam switch corresponding to the target TCI state may be reduced, increasing the likelihood that the one or more transmissions are properly received and, thereby, reducing retransmissions and the unnecessary power and processing consumption and wasted time and frequency resources associated with such retransmissions.

### Introduction to Wireless Communication Networks

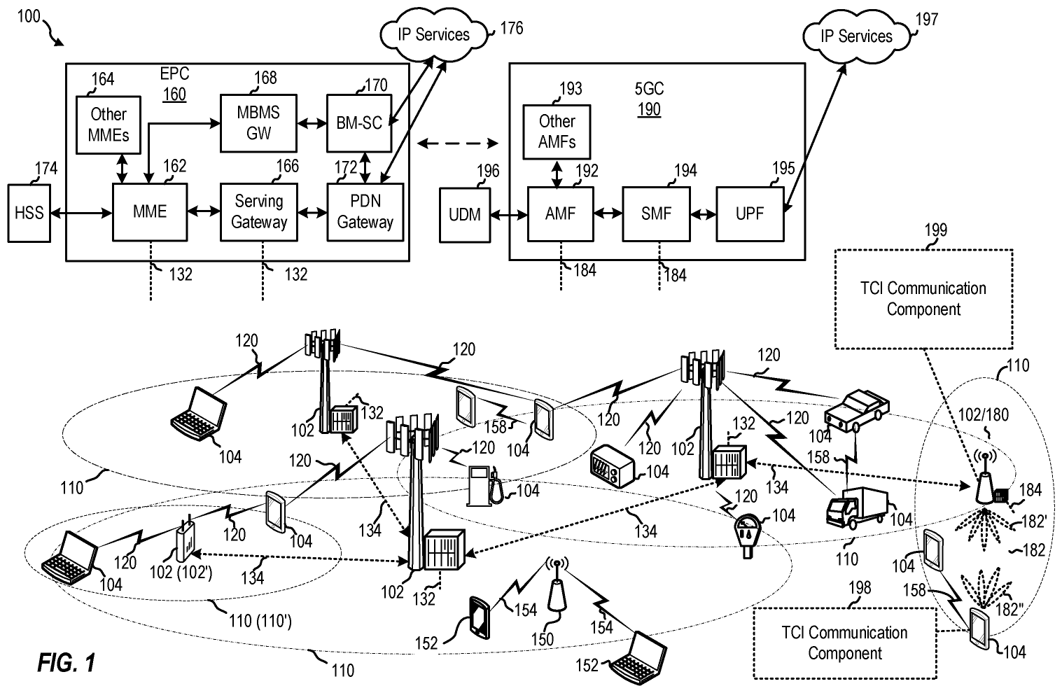

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IOT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

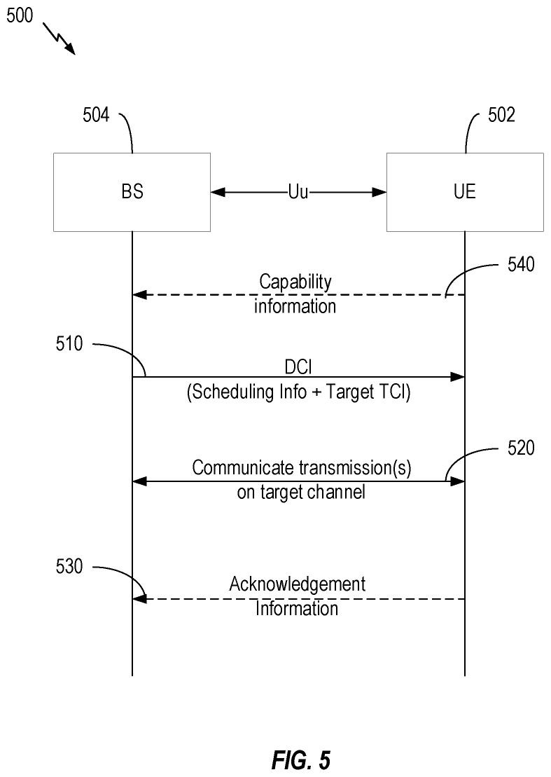

As shown, the BS 102 may include a TCI communication component 199, which may be configured to perform one or more of the operations illustrated in FIGS. 5-9, as well as other operations described herein for communicating based on a target TCI state associated with a dynamically transmitted target TCI prior to receiving an acknowledgement for the target TCI. Additionally, as shown, the UE 104 may include TCI communication component 198, which may be used configured to perform one or more of the operations illustrated in FIGS. 5-8 and 10, as well as other operations described herein for communicating using a target TCI state associated with a dynamically received target TCI prior to transmitting an acknowledgement for the target TCI.

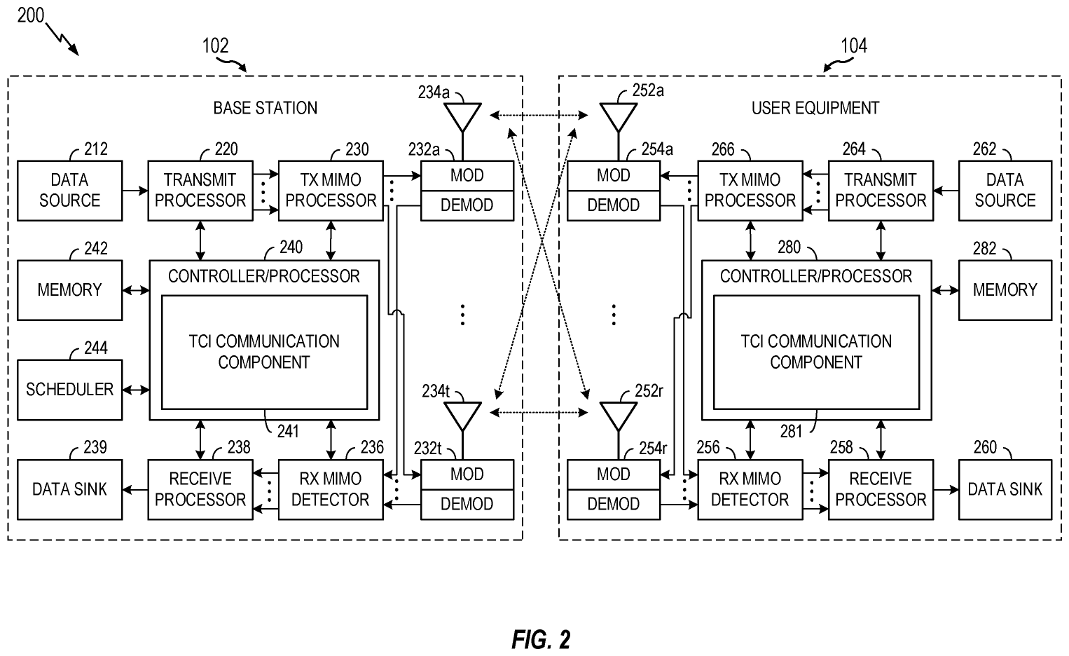

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes TCI communication component 241, which may be representative of TCI communication component 199 of FIG. 1. Notably, while depicted as an aspect of controller/processor 240, TCI communication component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes TCI communication component 281, which may be representative of TCI communication component 198 of FIG. 1. Notably, while depicted as an aspect of controller/processor 280, TCI communication component 281 may be implemented additionally or alternatively in various other aspects of user equipment 104 in other implementations.

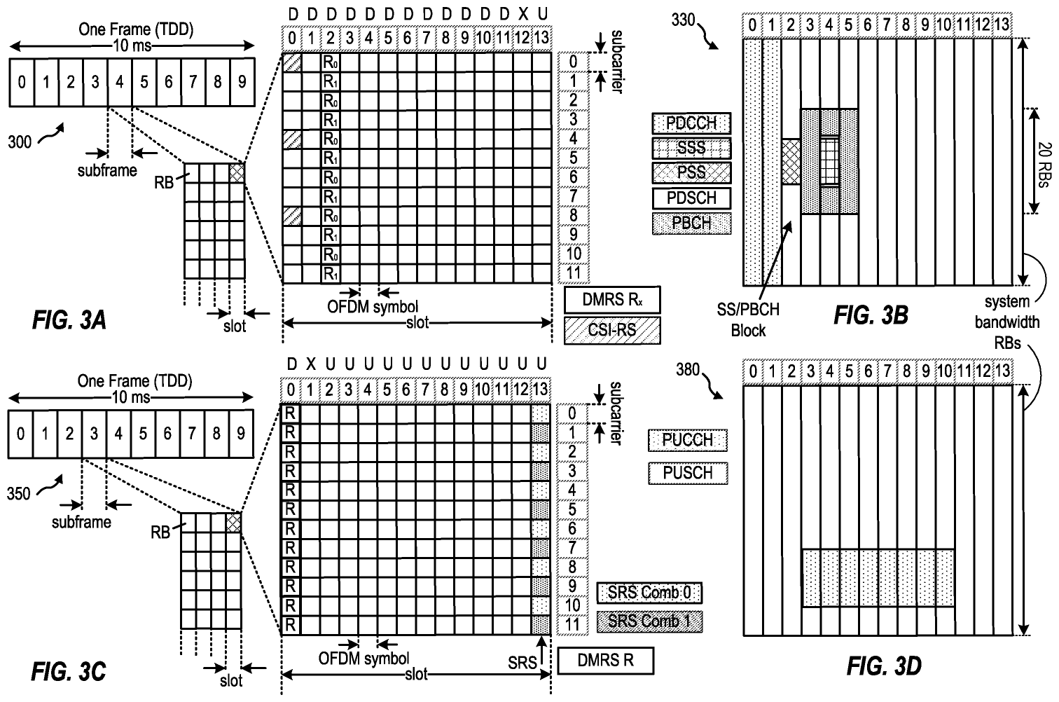

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Aspects Related to Transmission Configuration Indicator State Applicability Prior to Acknowledgement

In certain networks, such as 5G New Radio (NR) network, a user equipment may communicate with the network via one or more cells (e.g., one or more serving cells) and using one or more component carriers (or carrier bandwidths). In 5G, each component carrier may be defined by one or more bandwidth parts (BWPs). In some cases, a bandwidth part may be considered as a contiguous set of physical resource blocks, selected from a contiguous subset of the common resource blocks for a given numerology on a given carrier. In some cases, the UE may be configured with a maximum of four BWPs in the downlink (DL) and uplink (UL) for a given carrier.

Additionally, in certain cases, only one BWP for the given carrier may be active at any given time. For example, assuming that the UE is configured with four BWPs (BWP0, BWP1, BWP2, and BWP3), only one of the four BWPs may be active at a given time while the other BWPs remain inactive. However, while only one BWP may be active at a time, the active BWP may be switched to a different BWP. For example, assuming BWP1 is the active BWP, the active BWP may be switched to, for example, BWP2 or BWP3 based on certain criteria.

In some cases, the UE may be configured with a set of beam indications for communicating in one or more BWPs. For uplink transmission, the beam indication sets may be spatial relations. For downlink transmission, the beam indication sets may be transmission configuration indicator (TCI) states. The set of beam indications may be configured for a particular channel or type of transmission. The UE may be configured with the beam indication sets by higher layer signaling, such as radio resource control (RRC) signaling. In some examples, a subset of the configured sets may be activated via a medium access control element (MAC-CE). In some examples, an indication in downlink control information (DCI) may indicate (e.g., via a 3-bit indicator) one of the beam indications for the transmission scheduled by the DCI. The indicated TCI state or spatial relation may indicate to the UE the receive beam or transmit beam to use, respectively.

Different TCI beam indication types (or TCI state types) exist. For example, in some cases, the TCI beam indication types may include several single-channel beam indication types, such as (1) a separate DL single channel and/or RS TCI state to indicate a beam for a single DL channel and/or RS, (2) a separate UL single channel and/or RS TCI state to indicate a beam for a single UL channel and/or RS, and (3) UL spatial relation info to indicate a beam for a single UL channel and/or RS. Additionally, in some cases, the TCI beam indication types may include three additional multi-channel beam indication types, including (4) a joint DL/UL common TCI state to indicate a common beam for at least one DL channel and/or RS and at least one UL channel and/or RS, (5) a separate DL common TCI state to indicate a common beam for at least two DL channels and/or RSs, and (6) a separate UL common TCI state to indicate a common beam for at least two UL channels and/or RSs.

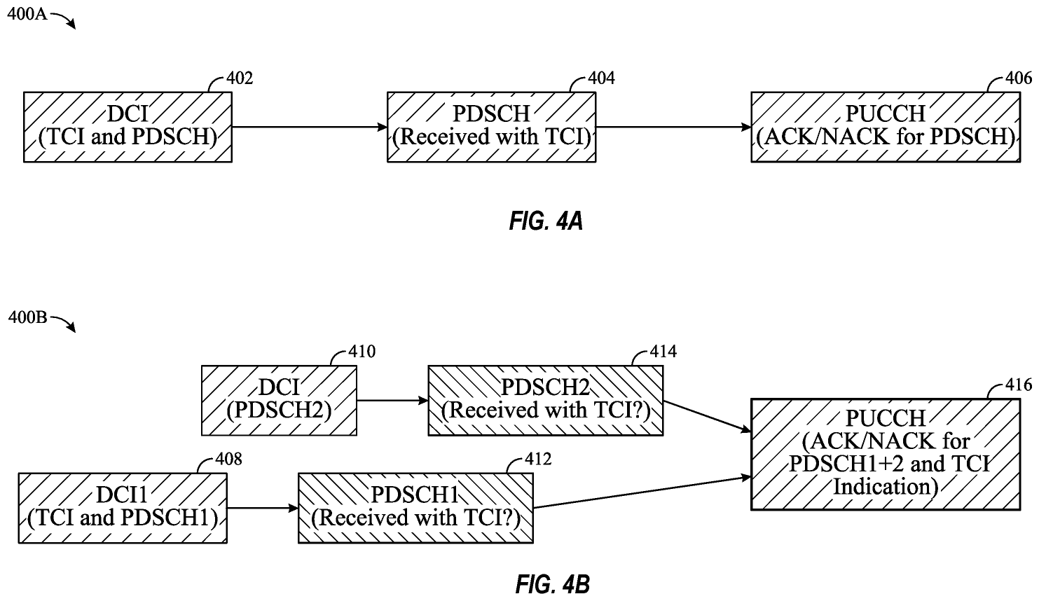

In general, these different TCI states may be dynamically configured by a TCI indicated within downlink control information (DCI) from a base station in a wireless communication network, such as the wireless communication network 100 of FIG. 1. However, when and under what conditions a UE may begin using a TCI state associated with an indicated TCI may be different for different 5G new radio (NR) standards releases, as illustrated in FIG. 4A and FIG. 4B.

For example, FIG. 4A is a process flow 400A illustrating dynamic TCI configuration and use of an associated TCI state for 5G NR Release 16. As shown at 402, a UE may receive a scheduling DCI that includes scheduling information for one or more transmissions on a target channel (e.g., PDSCH) as well as a target TCI associated with a target TCI state and the target channel. In Release 16, the TCI state associated with the indicated TCI may only be configured for only one transmission and only one target channel. Thereafter, as shown at 404, the UE may receive the one or more scheduled transmissions on the target channel (e.g., PDSCH) using the target TCI state associated with the indicated target TCI. In some cases, using the target TCI state to receive the one or more scheduled transmissions may include using a beam indicated by the target TCI state to receive the one or more schedule transmissions. The UE may then transmit signaling (e.g., a physical uplink control channel (PUCCH)) including acknowledgment information (e.g., positive acknowledgement (ACK) or negative acknowledgement (NACK)) for the one or more transmissions received on the PDSCH target channel, as shown at 406. As can be seen in FIG. 4A, under Release 16, the UE may begin using the target TCI state associated with the indicated target TCI without the need to acknowledge reception of the target TCI.

In contrast, in 5G NR Release 17, a dynamically configured target TCI may be applicable to multiple transmissions on multiple target channels. Additionally, it is not clear whether a target TCI state associated with the dynamically configured target TCI may be used prior to acknowledgement of the target TCI. For example, FIG. 4B is a process flow 400B illustrating dynamic TCI configuration and use of an associated TCI state for 5G NR Release 17. As shown, a UE may receive a first dynamic scheduling DCI including a target TCI and scheduling information for a first transmission on a target channel (e.g., PDSCH1). Additionally, the first scheduling DCI may include. Further, as shown, the UE may also receive a dynamic second scheduling DCI at 410 that includes scheduling information for a second transmission on the target channel (e.g., PDSCH2).

Thereafter, as shown at 412 and 414, the UE receives the first transmission (e.g., PDSCH1) and the second transmission (e.g., PDSCH2), respectively. The UE may then transmit signaling (e.g., a PUCCH) including acknowledgment information (e.g., ACK/NACK) for the first transmission and the second transmission, as illustrated at 416. Additionally, in contrast to Release 16, Release 17 may also require the UE to transmit acknowledgement information, acknowledging reception of the target TCI received at 408 in the first scheduling DCI. As shown, the acknowledgement information for the target TCI may be included within the PUCCH signaling transmitted at 416 that includes the acknowledgement information for the first transmission (e.g., PDSCH1) and the second PDSCH (e.g., PDSCH2).

In contrast to Release 16, the target TCI received at 408 in the first dynamic scheduling DCI may be associated with, or applicable to, multiple transmissions and multiple target channels in Release 17. For example, the target TCI may be applicable to both the first transmission on PDSCH1 received at 412 as well as the second transmission on PDSCH2 received at 414. However, because the UE is required to transmit acknowledgement information for the target DCI in Release 17 and because the target TCI may be applicable to multiple transmissions and multiple target channels, it is unclear whether the UE may use a target TCI state associated with the target TCI to receive transmissions on a target channel, such as the first transmission at 412 and the second transmission at 414, prior to transmitting acknowledgement information for the target TCI.

For example, if the UE is not able to use the target TCI state associated with the target TCI to communicate (e.g., transmit or receive) transmissions on the target channel, there may be significant latency in switching beams (e.g., indicated by the target TCI state) for communicating the transmissions. Such latency in switching beams may lead to the UE communicating the transmissions using sub-optimal beams, resulting in dropped transmissions. Retransmission may then need to be performed by either the base station or the UE, which unnecessarily consumes power resources at the base station and UE as well as time and frequency resources within a wireless communication network.

Thus, aspects of the present disclosure provide techniques for communicating using a target TCI state associated with a dynamically received target TCI prior to acknowledging reception of the TCI. In some cases, such communication may be based on whether at least one criterion is satisfied. For example, a wireless communication device, such as a base station (e.g., BS 102 of FIG. 1) or a user equipment (UE 104 of FIG. 1), may communicate one or more transmissions via a target channel using a target TCI state associated with the target TCI when at least one criterion is satisfied while the wireless communication device may communicate the one or more transmissions via the target channel using a default TCI state associated with a default TCI when the at least one criterion is not satisfied.

In some cases, the at least one criterion may include whether a time period between reception of the target TCI and communication of one or more transmissions is greater than a threshold amount of time. Additionally, in some cases, the at least one criterion may include whether capability information transmitted by the wireless communication device indicates support for the use of the target TCI state prior to transmission of signaling acknowledging the target TCI. For example, when the time period between reception of the target TCI and communication of one or more transmissions is greater than the threshold amount of time and/or when the capability information indicates support for the use of the target TCI state prior to transmission of signaling acknowledging the target TCI, the wireless communications device may communicate the one or more transmissions using the target TCI state associated with the target TCI prior to the transmission of the signaling acknowledging the target TCI. In such cases, latency associated with a beam switch corresponding to the target TCI state may be reduced, increasing the likelihood that the one or more transmissions are properly received and, thereby, reducing retransmissions and the unnecessary power consumption and wasted time and frequency resources associated with such retransmissions.

### Example Call Flow Illustrating Operations for Communicating Using a Dynamically Configured TCI State Prior to Acknowledgement

FIG. 5 is a call flow diagram illustrating example operations 500 between a BS 502 and a UE 504 communicating using a target TCI state associated with a dynamically received target TCI prior to acknowledgement of the received target TCI. In some cases, the BS 502 may be an example of the BS 102 in the wireless communication network 100 illustrated in FIG. 1. Similarly, the UE 504 may be an example of the UE 104 illustrated in FIG. 1. Further, as shown, a Uu interface may be established to facilitate communication between the BS 502 and UE 504, however, in other aspects, a different type of interface may be used.

As shown, the operations 500 illustrated in FIG. 5 begin at 510 with the UE 504 receiving, from the BS 502, a target TCI associated with a target TCI state and one or more target channels. In some cases, the one or more target channels may include at least one of a PDCCH, a PDSCH, or a PUSCH. Additionally, in some cases, the target TCI may be received in first downlink control information (DCI) message from the BS 502, which may include scheduling information for the one or more transmissions.

Thereafter, at 520, the UE 504 communicates one or more transmissions via a first target channel of the one or more target channels prior to transmitting signaling at 530 acknowledging the target TCI. As used herein, communicating the one or more transmissions may include, in some cases, receiving the one or more transmissions on the first target channel from the BS 502, such as PDSCH and/or PDCCH. In other cases, communicating the one or more transmissions may include transmitting the one or more transmissions on the first target channel to the BS 502, such as PUSCH and/or sounding reference signals (SRSs).

Thereafter, as shown at 530, the UE 504 may optionally transmit acknowledgement information to the BS 502. In some cases, the acknowledgement information may include a positive acknowledgement (ACK) or a negative acknowledgement (NACK) for the target TCI received at 510 as well as the one or more transmissions communicated via the target channel at 520 (e.g., such as an ACK/NACK for a PDSCH transmission).

In some cases, the UE may communicate the one or more transmissions via the first target channel using either the target TCI state or a default DCI state associated with a default TCI based on at least one criterion. For example, in some cases, the UE may communicate the one or more transmissions via the first target channel using the received target TCI state when the at least one criterion is satisfied. In other cases, the UE may communicate the one or more transmissions via the first target channel using the default TCI state when the at least one criterion is not satisfied.

In some cases, the at least one criterion may include a time period or time offset between reception of the target transmission configuration indicator and communication of one or more transmissions being greater than a threshold amount of time. In some cases, the threshold amount of time may include a minimum number of symbols needed to configure the UE 504 with the target TCI state (e.g., to decode the first DCI message and apply quasi colocation (QCL) information associated with the target TCI state) associated with the target TCI.

Accordingly, for example, when the time period or time offset between reception of the target TCI in the first DCI message and communication of the one or more transmissions is greater than the threshold amount of time, the UE 504 (as well as the BS 502) may communicate the one or more transmissions on the target channel using the target TCI state associated with the target TCI received at 510 in FIG. 5. In other cases, when the time period or time offset between reception of the target TCI in the first DCI message and communication of the one or more transmissions is less than or equal to the threshold amount of time, the UE 504 (as well as the BS 502) may communicate the one or more transmissions on the target channel using the default TCI state associated with the default TCI.

In some cases, the at least one criterion may be based on a capability of the UE 504. For example, in some cases, as shown at 540 in FIG. 5, the UE 504 may optionally transmit capability information to the BS 502. Generally, the capability information may include information indicating whether the UE 504 supports the use of a dynamically indicated TCI state (e.g., via DCI) prior to the transmission of acknowledgement information for a dynamically received TCI associated with the dynamically indicated TCI state. More specifically, the capability information may include information indicating whether the UE 504 supports the use of the target TCI state prior to transmitting signaling acknowledging the target TCI. In some cases, the capability information may be target-channel-specific. For example, in some cases, the UE may provide an indication that the UE is capable of using the target TCI state for a first target channel prior to transmitting the signaling acknowledging the target TCI while also providing another indication the UE is not capable of using the target TCI state for a second target channel prior to transmitting the signaling acknowledging the target TCI.

Accordingly, the at least one criterion may include the capability information indicating that the UE 504 supports the use of the target TCI state prior to transmitting signaling acknowledging the target TCI. For example, when the capability information indicates that the UE 504 supports the use of the target TCI state prior to transmitting signaling acknowledging the target TCI, communicating the one or more transmissions via the first target channel at 520 may include communicating the one or more transmissions via the first target channel using the target TCI state. However, when the capability information indicates that the UE 504 does not support the use of the target TCI state prior to transmitting signaling acknowledging the target TCI, communicating the one or more transmissions via the first target channel at 520 may include communicating the one or more transmissions via the first target channel using the default TCI state associated with a default TCI.

In some cases, the default TCI may include one or more pre-configured TCIs. For example, the default TCI may include a TCI with a lowest identifier (ID) or a QCL assumption with a lowest ID. In some cases, default TCI may include a TCI in a TCI codepoint with a lowest ID. In some cases, the default TCI may include a TCI that was most-recently received and acknowledged by the UE 504. For example, the UE 504 may receive another TCI in a second DCI message and may acknowledgement information for the other TCI prior to receiving the target TCI in the first DCI message. The UE 504 may then use this other TCI as the default TCI when communicating the one or more transmissions via the first target channel (e.g., when the at least one criterion is not satisfied).

It should be noted that there may be a certain error probability associated with communicating the one or more transmissions using the target TCI state prior to the transmission of the acknowledgement information due to misdetection by the UE 504 of the target TCI in the first DCI message. For example, there may be instances in which the target TCI is communicated by the BS 502 to the UE 504 but the UE 504 does not properly receive the target TCI. Accordingly, in such cases, if the one or more transmissions are communicated (e.g., transmitted) by the BS 502 to the UE 504 using the target TCI, the UE 504 may not be able to properly receive the one or more transmissions (e.g., due to using an improper beam). In such cases, the BS 502 may account for this error probability by performing one or more retransmissions, including retransmitting the target TCI and the one or more transmissions.

### Example Process Flows for Communicating Using a Dynamically Configured TCI State Prior to Acknowledgement for Different Target Channels

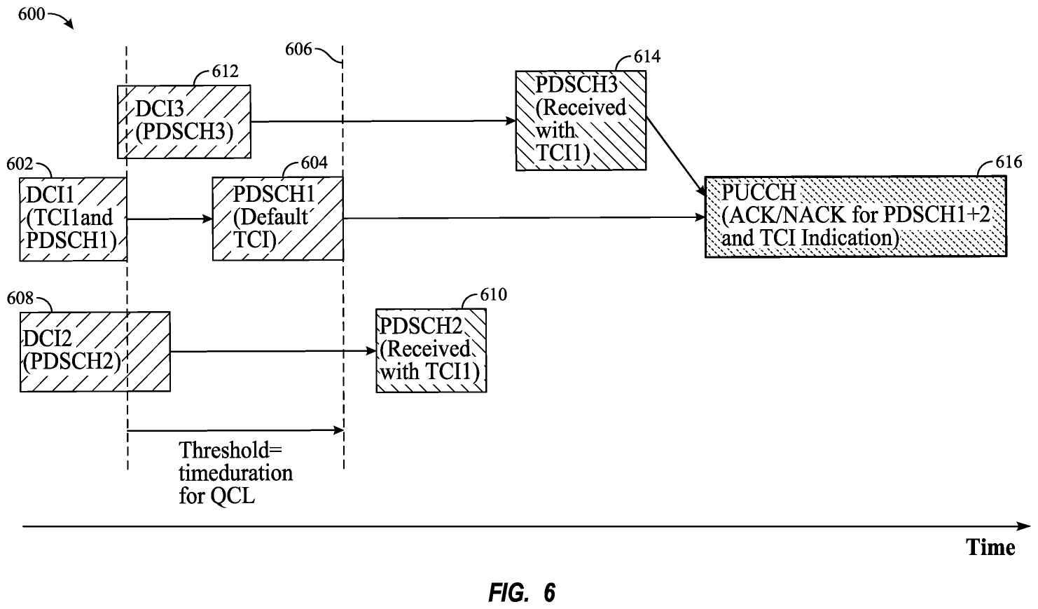

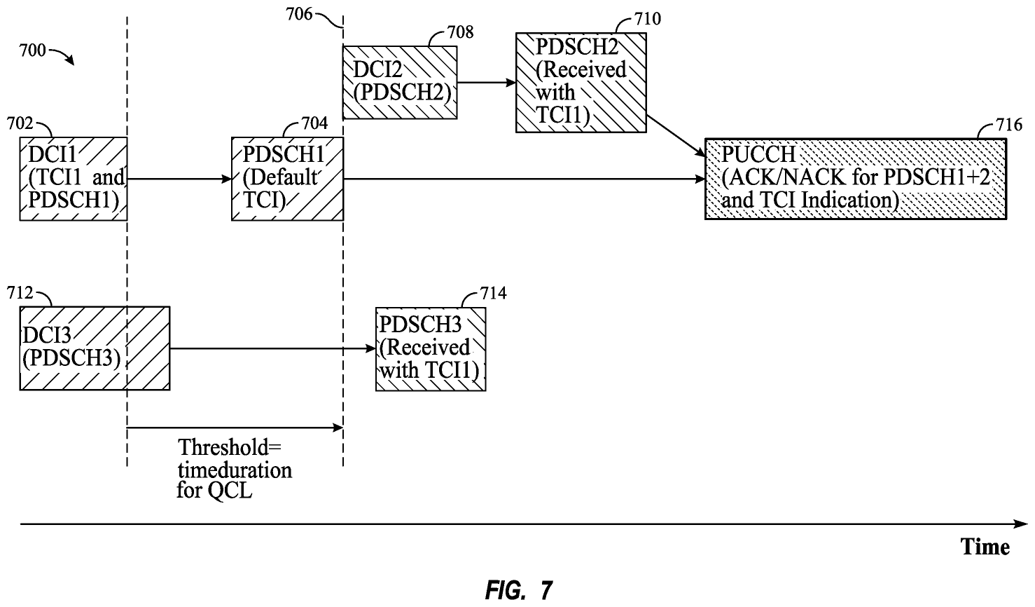

FIG. 6 and FIG. 7 illustrate process flows for communicating using a target TCI state prior to acknowledgement of an associated target TCI for different types of target channels. For example, FIG. 6 illustrates a process flow 600 for communicating using a dynamically configured target TCI state prior to acknowledgement for a PDSCH target channel. FIG. 7 illustrates a process flow 700 for communicating using a dynamically configured target TCI state prior to acknowledgement for any type of target channel, such as PDCCH, PDSCH, PUSCH, or SRS. According to aspects, it should be noted that communicating using the dynamically configured TCI state shown in the process flows 600 and 700 may assume that a UE has transmitted capability information to a BS indicating that the UE supports the use of the dynamically configured target TCI state prior to the transmission of acknowledgement information for a dynamically received target TCI associated with the dynamically configured target TCI state.

As illustrated in FIG. 6, a UE (e.g., UE 104 of FIG. 1 and/or UE 504 of FIG. 5) receives a first DCI message (e.g., DCI1) at 602 from a BS. The first DCI message may include a target TCI (e.g., TCI1) associated with a target TCI state and a first target channel of one or more target channels. Additionally, the first DCI message may include scheduling information for a first transmission of one or more transmissions on the first target channel, such as a PDSCH. In some cases, the target TCI may apply not only to the first transmission on the first target channel scheduled by the first DCI message (e.g., in which the target TCI is carried), but also to other target channels and transmissions scheduled by other DCI messages (e.g., unlike 5G NR Release 16), as described below.

As illustrated at 604, the first transmission (e.g., PDSCH1) may be scheduled to occur before a threshold amount of time 606 after receiving the target TCI in the first DCI message. As noted above, the threshold amount of time 606 (e.g., also known as a “timeDurationForQCL” parameter) may include a minimum number of symbols needed to configure the UE 504 with the target TCI state. In other words, the threshold amount of time 606 is the minimum amount of time (in symbols) for the UE to decode the first DCI message and to switch a beam based on QCL information associated with the target TCI. According to aspects, because the first transmission at 604 is scheduled before the threshold amount of time 606, the UE may use a default TCI state, as described above, to communicate the first transmission (e.g., to receive PDSCH1 from the BS) prior to transmitting acknowledgement information to the BS for the target TCI.

Further, as illustrated at 608, the UE also receives a second DCI message (e.g., DCI2) from the BS, including scheduling information that schedules a second transmission (e.g., PDSCH2) of the one or more transmissions via a second target channel (e.g., to which the target TCI applies) of the one or more target channels. In some cases, the target TCI received in the first DCI message may also apply to the second target channel. Accordingly, because the second DCI message is received before the threshold amount of time 606 after receiving the target TCI, the UE may receive the second DCI message using a default TCI state. However, as shown at 610, in contrast to the first transmission, the second transmission is scheduled to occur after the threshold amount of time 606. As such, the UE may use the target TCI state to communicate the second transmission (e.g., to receive PDSCH2 from the BS) prior to transmitting acknowledgement information to the BS for the target TCI.

Similarly, as shown at 612, the UE also receives a third DCI message (e.g., DCI3) from the BS, including scheduling information that schedules a third transmission (e.g., PDSCH3) of the one or more transmissions via a third target channel of the one or more target channels. In some cases, the target TCI received in the first DCI message may also apply to the third target channel. Accordingly, because the third DCI message is received before the threshold amount of time 606 after receiving the target TCI, the UE may receive the third DCI message using a default TCI state. In contrast, as shown at 614, the third transmission is scheduled to occur after the threshold amount of time 606. As such, the UE may use the target TCI state to communicate the third transmission (e.g., to receive PDSCH3 from the BS) prior to transmitting acknowledgement information to the BS for the target TCI.

Thereafter, as illustrated at 616, the UE may transmit signaling (e.g., PUCCH) acknowledging the reception of the target TCI to the BS. In some aspects, the signaling acknowledging reception of the target TCI may also include acknowledgement information for the one or more transmissions, such as the first transmission and the third transmission. In some cases, the signaling acknowledging reception of the target TCI may also include acknowledgement information for the second transmission; however, in other cases, the UE may transmit the acknowledgement information for the second transmission separately.

As discussed above, in certain cases, the target TCI may apply to additional target channels other than PDSCH. For example, FIG. 7 illustrates a process flow 700 for communicating using a dynamically configured target TCI state prior to acknowledgement for a PDSCH target channel as well as a PDCCH target channel.

As illustrated in FIG. 7, a UE (e.g., UE 104 of FIG. 1 and/or UE 504 of FIG. 5) receives a first DCI message (e.g., DCI1) at 702 from a BS. The first DCI message may include a target TCI (e.g., TCI1) associated with a target TCI state and a first target channel (e.g., PDSCH) of one or more target channels. Additionally, the first DCI message may include scheduling information for a first transmission (e.g., PDSCH1) of one or more transmissions on the first target channel, such as a PDSCH. In some cases, the target TCI may apply not only to the first transmission on the first target channel scheduled by the first DCI message (e.g., in which the target TCI is carried), but also to other target channels and transmissions scheduled by other DCI messages (e.g., unlike 5G NR Release 16). As noted above, the target TCI may apply to both PDSCH as well as PDCCH in the shown in FIG. 7. However, it should be understood that the target TCI may also apply to other target channels, such as PUSCH and SRS.

As illustrated at 704, the first transmission (e.g., PDSCH1) may be scheduled to occur before a threshold amount of time 706 after receiving the target TCI in the first DCI message. Accordingly, because the first transmission at 704 is scheduled before the threshold amount of time 706, the UE may use a default TCI state, as described above, to communicate the first transmission (e.g., to receive PDSCH1 from the BS) prior to transmitting acknowledgement information to the BS for the target TCI.

Further, as illustrated at 708, the UE also receives a second DCI message (e.g., DCI2) from the BS via a second target channel (e.g., PDCCH), including scheduling information that schedules a second transmission (e.g., PDSCH2) of the one or more transmissions via a third target channel (e.g., PDSCH) of the one or more target channels. In some cases, the target TCI received in the first DCI message may also apply to the second target channel (e.g., PDCCH) and third target channel (e.g., PDSCH). Further, in contrast to the second DCI message and third DCI message of FIG. 6, the second DCI message of FIG. 7, is received after the threshold amount of time 706 after receiving the target TCI. Accordingly, in this case, the UE in FIG. 7 may receive the second DCI message at 708 via the second target channel (e.g., PDCCH) using the target TCI state associated with the target TCI received in the first DCI message. Thereafter, the UE may then receive the second transmission (e.g., PDSCH2) via the third target channel (e.g., PDSCH) at 710. Additionally, because the second transmission (e.g., PDSCH2) is scheduled by the second DCI message to occur after the threshold amount of time 706, as shown, the UE may also use the target TCI state to communicate the second transmission (e.g., to receive the second transmission from the BS) prior to transmitting acknowledgement information to the BS for the target TCI.

Further, as shown at 712, the UE also receives a third DCI message (e.g., DCI3) from the BS, including scheduling information that schedules a third transmission (e.g., PDSCH3) of the one or more transmissions via a fourth target channel (e.g., PDSCH) of the one or more target channels. In some cases, the target TCI received in the first DCI message may also apply to the fourth target channel. Accordingly, because the third DCI message is received before the threshold amount of time 706 after receiving the target TCI, the UE may receive the third DCI message using a default TCI state. In contrast, as shown at 714, the third transmission is scheduled to occur after the threshold amount of time 706. As such, the UE may use the target TCI state to communicate the third transmission (e.g., to receive PDSCH3 from the BS) prior to transmitting acknowledgement information to the BS for the target TCI.

Thereafter, as illustrated at 716, the UE may transmit signaling (e.g., PUCCH) acknowledging the reception of the target TCI to the BS. The signaling acknowledging reception of the target TCI may also include acknowledgement information for the one or more transmissions, such as the first transmission and the second transmission. In some cases, the signaling acknowledging reception of the target TCI may also include acknowledgement information for the third transmission; however, in other cases, the UE may transmit the acknowledgement information for the third transmission separately from the signaling transmitted at 716.

### Additional Considerations Regarding Multi-Beam Operation

In some cases, a UE may support multi-beam operation in which the UE may use multiple TCI states for a particular target channel (e.g., a first TCI state for a first PDSCH and a second or default TCI state for a second PDSCH) or across different target channels (e.g., a first TCI state for PDSCH and a second TCI state for PUSCH). Accordingly, in such cases, the techniques described above with respect to communicating using a dynamically configured TCI state prior to acknowledgement of an associated dynamically received TCI may also be applicable to multi-beam operation.

To support the use of multiple TCI states under multi-beam operation when communicating one or more transmissions prior to acknowledgement of a dynamically received TCI, the UE may use a target TCI state associated with a target TCI received in a DCI message to communicate transmissions on one or more target channels (e.g., PDSCH and/or PUSCH) that are scheduled by a same DCI (e.g., transmissions that are co-scheduled in the same DCI message). For example, the UE may receive a first DCI message that includes a first target TCI and that schedules a first transmission on a PUSCH target channel and a second transmission on a PDSCH target channel. Because the first transmission and the second transmission are co-scheduled in the first DCI message, the UE may use a target TCI state associated with the target TCI to communicate the first transmission and the second transmission, provided that the first transmission and the second transmission are scheduled after a threshold amount of time after reception of the first DCI message.

Alternatively, the UE may use a previous or a default TCI state associated with a default TCI for communicating transmissions that are not scheduled by the same DCI (e.g., transmissions that are not co-scheduled in the same DCI). For example, in some cases, the UE may receive a first DCI message that includes a first target TCI and that schedules a first transmission on a PDSCH target channel. Additionally, the UE may receive a second DCI message that schedules a second transmission on a PUSCH target channel. In such cases, because the first transmission and the second transmission are not co-scheduled in the first DCI message, the UE may use a target TCI state associated with the target TCI to communicate the first transmission (e.g., provided that the first transmission is scheduled after the threshold amount of time after reception of the first DCI message) and may use a previous or default TCI state to communicate the second transmission.

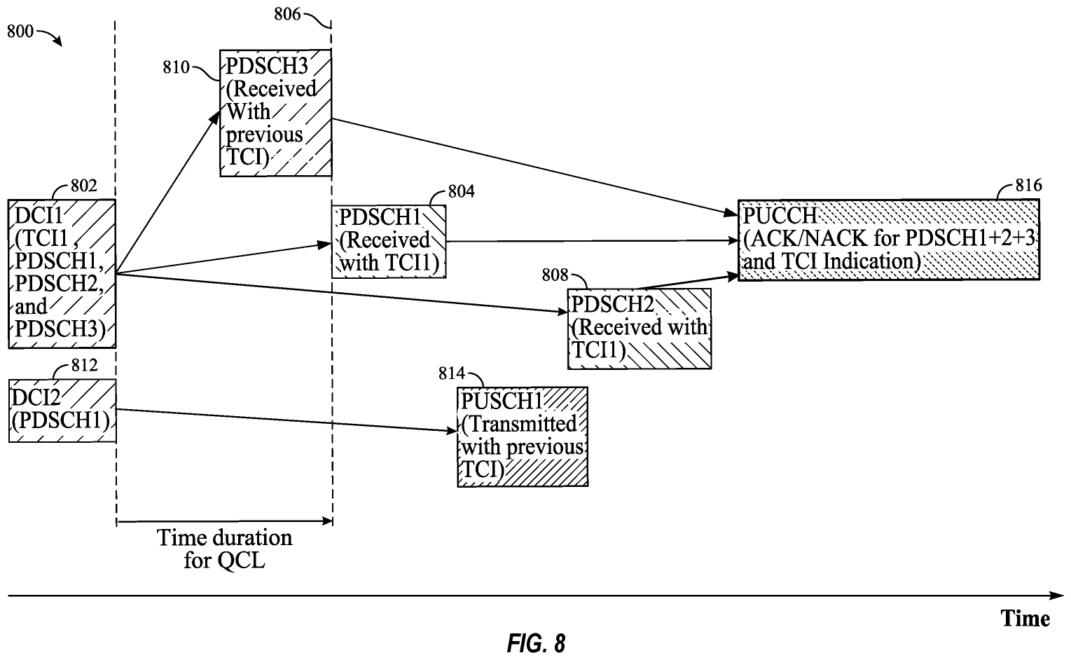

FIG. 8 illustrates a process flow 800 for communicating using a dynamically configured TCI state prior to acknowledgement of an associated dynamically received TCI for multi-beam operation.

For example, as illustrated in FIG. 8, a UE (e.g., UE 104 of FIG. 1 and/or UE 504 of FIG. 5) receives a first DCI message (e.g., DCI1) at 802 from a BS. The first DCI message may include a target TCI (e.g., TCI1) associated with a target TCI state and one or more target channels. Additionally, the first DCI message may include scheduling information for a first transmission of one or more transmissions on a first target channel (e.g., a PDSCH1) to occur at 804, a second transmission on a second target channel (e.g., PDSCH2) to occur at 806, and a third transmission on a third target channel (e.g., PDSCH3) to occur at 808.

Accordingly, thereafter, the UE may communicate the first transmission (e.g., receive PDSCH1 from the BS) on the first target channel at 804. Further, because the first transmission is scheduled to occur after a threshold amount of time 806 after reception of the first DCI message, the UE may use the target TCI state to communicate the first transmission. Additionally, as shown at 808, the UE may communicate the second transmission (e.g., receive PDSCH2 from the BS), which is also scheduled after the threshold amount of time 806, using the target TCI state since the second transmission is co-scheduled with the first transmission in the first DCI message. Further, the UE may also communicate the third transmission (e.g., receive PDSCH3 from the BS) at 810. However, because the third transmission is scheduled to occur prior to the threshold amount of time 806, the UE uses a previous or default TCI state to communicate the third transmission.

Additionally, as illustrated at 812, the UE may receive a second DCI message that includes scheduling information for a fourth transmission on a fourth target channel (e.g., PUSCH1) to occur at 814. While the fourth transmission is scheduled to occur at 814 after the threshold amount of time 806, the UE may use the previous or default TCI state to communicate the fourth transmission (e.g., transmit PUSCH1 to the BS) since the fourth transmission is scheduled in the second DCI message and not co-scheduled with the first, second, and third transmissions in the first DCI message.

Thereafter, as illustrated at 816, the UE may transmit signaling (e.g., PUCCH) to the BS acknowledging the target TCI received in the first DCI message. The signaling acknowledging reception of the target TCI may also include acknowledgement information for the one or more transmissions, such as the first transmission, the second transmission, and the third transmission, as shown.

### Example Methods for Communicating Using a Dynamically Configured TCI State Prior to Acknowledgement

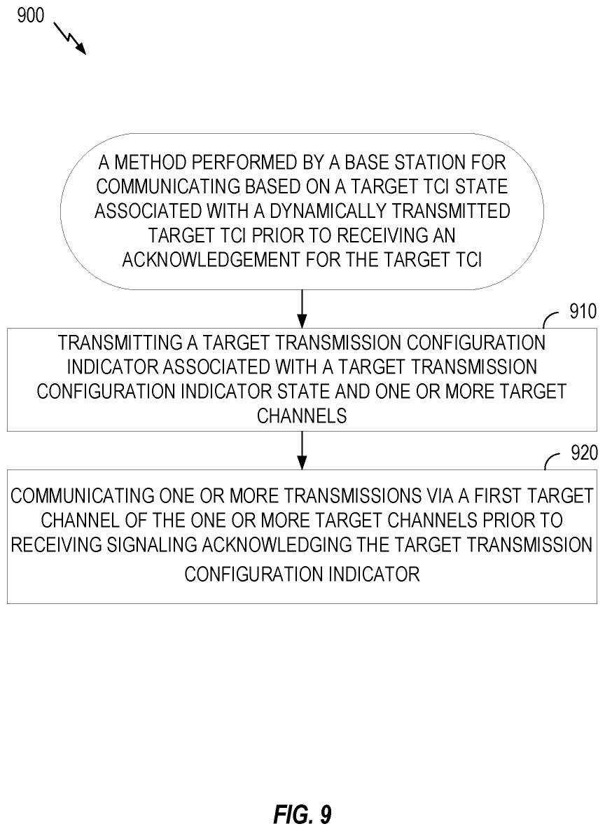

FIG. 9 is a flow diagram illustrating example operations 900 for wireless communication. The operations 900 may be performed, for example, by a BS (e.g., such as the BS 102 in the wireless communication network 100 of FIG. 1) for communicating based on a target TCI state associated with a dynamically transmitted target TCI prior to receiving an acknowledgement for the target TCI. The operations 900 may be implemented as software components that are executed and run on one or more processors (e.g., controller/processor 240 of FIG. 2). Further, the transmission and reception of signals by the BS in operations 900 may be enabled, for example, by one or more antennas (e.g., antennas 234 of FIG. 2). In certain aspects, the transmission and/or reception of signals by the BS may be implemented via a bus interface of one or more processors (e.g., controller/processor 240, including the TCI communication component 241) obtaining and/or outputting signals.

The operations 900 begin at 910 with transmitting a target transmission configuration indicator associated with a target transmission configuration indicator state and one or more target channels.

In block 920, the BS communicates one or more transmissions via a first target channel of the one or more target channels prior to receiving signaling acknowledging the target transmission configuration indicator. In some cases, communicating the one or more transmissions via the first target channel may include communicating the one or more transmissions via the first target channel using the target transmission configuration indicator state when at least one criterion is satisfied. In some cases, communicating the one or more transmissions via the first target channel may include communicating the one or more transmissions via the first target channel using a default transmission configuration indicator state associated with a default transmission indicator when the at least one criterion is not satisfied.

In some cases, the at least one criterion comprises a time period between transmission of the target transmission configuration indicator and communication of one or more transmissions being greater than a threshold amount of time.

In some cases, the operations 900 further include receiving capability information indicating whether the UE supports the use of the target transmission configuration indicator state prior to transmitting signaling acknowledging the target transmission configuration indicator. In such cases, the at least one criterion comprises the capability information indicating that the UE supports the use of the target transmission configuration indicator state prior to transmitting signaling acknowledging the target transmission configuration indicator.

In some cases, the default transmission configuration indicator comprises a transmission configuration indicator with a lowest identifier (ID) or a quasi-colocation (QCL) assumption with a lowest ID.

In some cases, the default transmission configuration indicator comprises a transmission configuration indicator in a transmission configuration indicator codepoint with a lowest identifier (ID).

In some cases, the operations 900 further include transmitting the default transmission configuration indicator and receiving acknowledgement information for the default transmission configuration indicator prior to receiving the target transmission configuration indicator.

In some cases, the operations 900 further include receiving the signaling acknowledging the reception of the target transmission configuration indicator. In some cases, the signaling acknowledging reception of the target transmission configuration indicator further comprises acknowledgement information for the one or more transmissions.

In some cases, transmitting the target transmission configuration indicator comprises transmitting the target transmission configuration indicator in a first downlink control information (DCI) message that schedules a first transmission of the one or more transmissions.

In some cases, the operations 900 further include transmitting a second DCI message, via a second target channel of the one or more target channels, that schedules a second transmission of the one or more transmissions.

In some cases, transmitting the second DCI message comprises transmitting the second DCI message before a threshold amount of time after receiving the target transmission configuration indicator using the default transmission configuration indicator state. In some cases, the threshold amount of time comprises a minimum number of symbols needed to configure the UE with the target transmission configuration indicator state.

In some cases, transmitting the second DCI message comprises transmitting the second DCI message after a threshold amount of time after receiving the target transmission configuration indicator using the target transmission configuration indicator state. In such cases, the operations 900 further include communicating the second transmission of the one or more transmissions via the first target channel using the target transmission configuration indicator state. In some cases, the first target channel comprises a physical downlink shared channel (PDSCH) or a physical uplink shared channel (PUSCH) and the second target channel comprises a physical downlink control channel (PDCCH).

In some cases, communicating one or more transmissions comprises communicating the first transmission of the one or more transmissions after a threshold amount of time after receiving the target transmission configuration indicator using the target transmission configuration indicator and communicating the second transmission of the one or more transmissions after the threshold amount of time after receiving the target transmission configuration indicator using the default transmission configuration indicator state.

In some cases, the operations 900 further include receiving the signaling acknowledging the reception of the target transmission configuration indicator, wherein the signaling further includes acknowledgement information for the first transmission and the second transmission.

Notably, FIG. 9 is just one example, and additional and/or alternative methods consistent with the disclosure herein are possible.

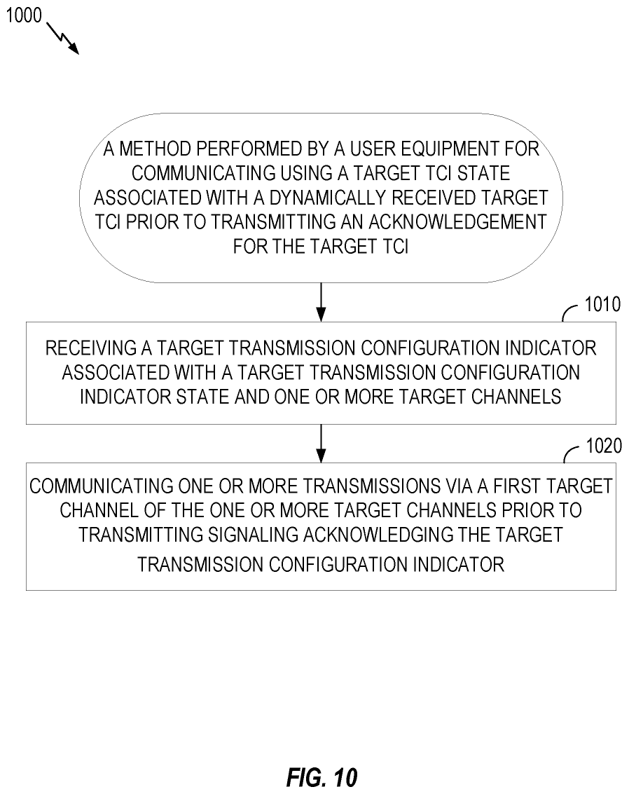

FIG. 10 is a flow diagram illustrating example operations 1000 for wireless communication, in accordance with certain aspects of the present disclosure. The operations 1000 may be performed, for example, by a UE (e.g., such as the UE 104 in the wireless communication network 100 of FIG. 1) for communicating using a target TCI state associated with a dynamically received target TCI prior to transmitting an acknowledgement for the target TCI. The operations 1000 may be complementary to the operations 900 performed by the BS. The operations 1000 may be implemented as software components that are executed and run on one or more processors (e.g., controller/processor 280 of FIG. 2). Further, the transmission and reception of signals by the UE in operations 1000 may be enabled, for example, by one or more antennas (e.g., antennas 252 of FIG. 2). In certain aspects, the transmission and/or reception of signals by the UE may be implemented via a bus interface of one or more processors (e.g., controller/processor 280, including the TCI communication component 281) obtaining and/or outputting signals.

The operations 1000 begin at 1010 with receiving a target transmission configuration indicator associated with a target transmission configuration indicator state and one or more target channels.

In block 1020, the UE communicates one or more transmissions via a first target channel of the one or more target channels prior to transmitting signaling acknowledging the target transmission configuration indicator. In some cases, communicating the one or more transmissions via the first target channel comprises communicating the one or more transmissions via the first target channel using the target transmission configuration indicator state when at least one criterion is satisfied. In some cases, communicating the one or more transmissions via the first target channel comprises communicating the one or more transmissions via the first target channel using a default transmission configuration indicator state associated with a default transmission indicator when the at least one criterion is not satisfied.

In some cases, the at least one criterion comprises a time period between reception of the target transmission configuration indicator and communication of one or more transmissions being greater than a threshold amount of time.

In some cases, the operations 1000 further include transmitting capability information indicating whether the UE supports the use of the target transmission configuration indicator state prior to transmitting signaling acknowledging the target transmission configuration indicator. In such cases, the at least one criterion comprises the capability information indicating that the UE supports the use of the target transmission configuration indicator state prior to transmitting signaling acknowledging the target transmission configuration indicator.

In some cases, the default transmission configuration indicator comprises a transmission configuration indicator with a lowest identifier (ID) or a quasi-colocation (QCL) assumption with a lowest ID.

In some cases, the default transmission configuration indicator comprises a transmission configuration indicator in a transmission configuration indicator codepoint with a lowest identifier (ID).

In some cases, the operations 1000 further include receiving the default transmission configuration indicator and transmitting acknowledgement information for the default transmission configuration indicator prior to receiving the target transmission configuration indicator.

In some cases, the operations 1000 further include transmitting the signaling acknowledging the reception of the target transmission configuration indicator. In such cases, the signaling acknowledging reception of the target transmission configuration indicator further comprises acknowledgement information for the one or more transmissions.

In some cases, receiving the target transmission configuration indicator comprises receiving the target transmission configuration indicator in a first downlink control information (DCI) message that schedules a first transmission of the one or more transmissions.

In some cases, the operations 1000 further include receiving a second DCI message, via a second target channel of the one or more target channels, that schedules a second transmission of the one or more transmissions.

In some cases, receiving the second DCI message comprises receiving the second DCI message before a threshold amount of time after receiving the target transmission configuration indicator using the default transmission configuration indicator state. In some cases, the threshold amount of time comprises a minimum number of symbols needed to configure the UE with the target transmission configuration indicator state.

In some cases, receiving the second DCI message comprises receiving the second DCI message after a threshold amount of time after receiving the target transmission configuration indicator using the target transmission configuration indicator state. In such cases, the operations 1000 further include communicating the second transmission of the one or more transmissions via the first target channel using the target transmission configuration indicator state. In some cases, the first target channel comprises a physical downlink shared channel (PDSCH) or a physical uplink shared channel (PUSCH) and the second target channel comprises a physical downlink control channel (PDCCH).

In some cases, communicating one or more transmissions comprises communicating the first transmission of the one or more transmissions after a threshold amount of time after receiving the target transmission configuration indicator using the target transmission configuration indicator and communicating the second transmission of the one or more transmissions after the threshold amount of time after receiving the target transmission configuration indicator using the default transmission configuration indicator state.

In some cases, the operations 1000 further include transmitting the signaling acknowledging the reception of the target transmission configuration indicator, wherein the signaling further includes acknowledgement information for the first transmission and the second transmission.

Notably, FIG. 10 is just one example, and additional and/or alternative methods consistent with the disclosure herein are possible.

### Example Wireless Communication Devices

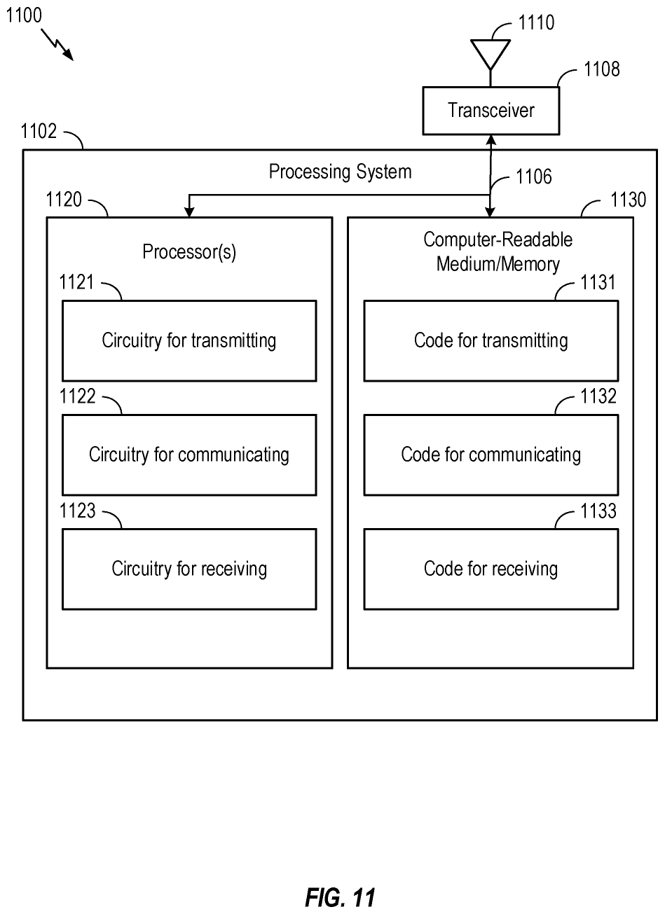

FIG. 11 depicts an example communication device 1100 that includes various components operable, configured, or adapted to perform operations for the techniques disclosed herein, such as the operations depicted and described with respect to FIGS. 5-9. In some examples, communication device 1100 may be a base station 102 as described, for example with respect to FIGS. 1 and 2.

Communications device 1100 includes a processing system 1102 coupled to a transceiver 1108 (e.g., a transmitter and/or a receiver). Transceiver 1108 is configured to transmit (or send) and receive signals for the communications device 1100 via an antenna 1110, such as the various signals as described herein. Processing system 1102 may be configured to perform processing functions for communications device 1100, including processing signals received and/or to be transmitted by communications device 1100.

Processing system 1102 includes one or more processors 1120 coupled to a computer-readable medium/memory 1130 via a bus 1106. In certain aspects, computer-readable medium/memory 1130 is configured to store instructions (e.g., computer-executable code) that when executed by the one or more processors 1120, cause the one or more processors 1120 to perform the operations illustrated in FIGS. 5-9, or other operations for performing the various techniques discussed herein for communicating based on a target TCI state associated with a dynamically transmitted target TCI prior to receiving an acknowledgement for the target TCI.

In the depicted example, computer-readable medium/memory 1130 stores code 1131 for transmitting, code 1132 for communicating, and code 1133 for receiving.

In the depicted example, the one or more processors 1120 include circuitry configured to implement the code stored in the computer-readable medium/memory 1130, including circuitry 1121 for transmitting, circuitry 1122 for communicating, and circuitry 1123 for receiving.

Various components of communications device 1100 may provide means for performing the methods described herein, including with respect to FIGS. 5-9.

In some examples, means for transmitting or sending (or means for outputting for transmission), as well as means for communicating, may include the transceivers 232 and/or antenna(s) 234 of the base station 102 illustrated in FIG. 2 and/or transceiver 1108 and antenna 1110 of the communication device 1100 in FIG. 11.

In some examples, means for receiving (or means for obtaining), as well as means for communicating, may include the transceivers 232 and/or antenna(s) 234 of the base station illustrated in FIG. 2 and/or transceiver 1108 and antenna 1110 of the communication device 1100 in FIG. 11.

Notably, FIG. 11 is just one example, and many other examples and configurations of communication device 1100 are possible.

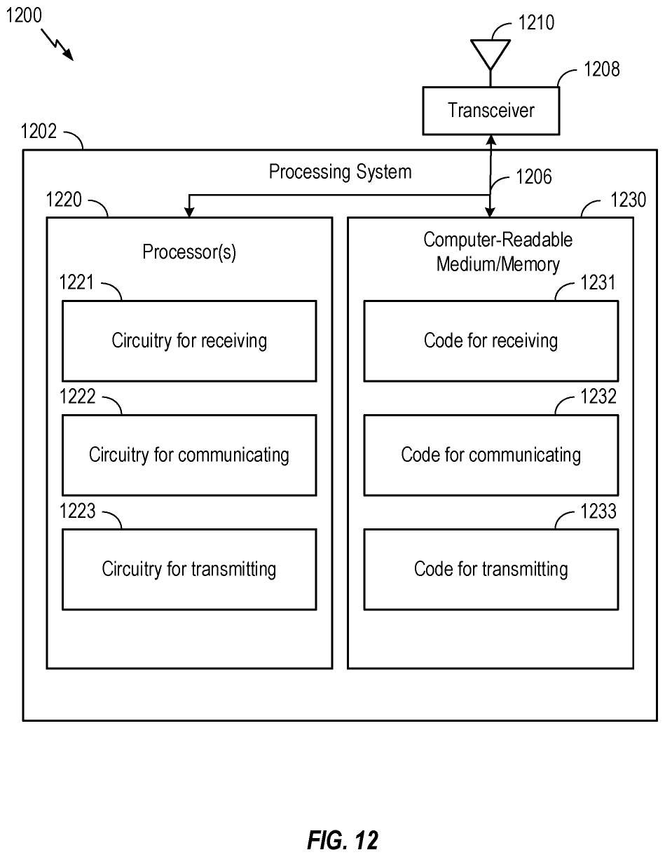

FIG. 12 depicts an example communication device 1200 that includes various components operable, configured, or adapted to perform operations for the techniques disclosed herein, such as the operations depicted and described with respect to FIGS. 5-8 and FIG. 10. In some examples, communication device 1200 may be a user equipment 104 as described, for example with respect to FIGS. 1 and 2.

Communications device 1200 includes a processing system 1202 coupled to a transceiver 1208 (e.g., a transmitter and/or a receiver). Transceiver 1208 is configured to transmit (or send) and receive signals for the communications device 1200 via an antenna 1210, such as the various signals as described herein. Processing system 1202 may be configured to perform processing functions for communications device 1200, including processing signals received and/or to be transmitted by communications device 1200.

Processing system 1202 includes one or more processors 1220 coupled to a computer-readable medium/memory 1230 via a bus 1206. In certain aspects, computer-readable medium/memory 1230 is configured to store instructions (e.g., computer-executable code) that when executed by the one or more processors 1220, cause the one or more processors 1220 to perform the operations illustrated in FIGS. 5-8 and FIG. 10, or other operations for performing the various techniques discussed herein for communicating using a target TCI state associated with a dynamically received target TCI prior to transmitting an acknowledgement for the target TCI.

In the depicted example, computer-readable medium/memory 1230 stores code 1231 for receiving, code 1232 for communicating, and code 1233 for transmitting.

In the depicted example, the one or more processors 1220 include circuitry configured to implement the code stored in the computer-readable medium/memory 1230, including circuitry 1221 for receiving, circuitry 1222 for communicating, and circuitry 1223 for transmitting.

Various components of communications device 1200 may provide means for performing the methods described herein, including with respect to 5-8 and FIG. 10.

In some examples, means for transmitting or sending (or means for outputting for transmission), as well as means for communicating, may include the transceivers 254 and/or antenna(s) 252 of the user equipment 104 illustrated in FIG. 2 and/or transceiver 1208 and antenna 1210 of the communication device 1200 in FIG. 12.

In some examples, means for receiving (or means for obtaining), as well as means for communicating, may include the transceivers 254 and/or antenna(s) 252 of the user equipment 104 illustrated in FIG. 2 and/or transceiver 1208 and antenna 1210 of the communication device 1200 in FIG. 12.

Notably, FIG. 12 is just one example, and many other examples and configurations of communication device 1200 are possible.

### Example Clauses

Implementation examples are described in the following numbered clauses:

Clause 1: A method for wireless communication by a user equipment (UE), comprising: receiving a target transmission configuration indicator associated with a target transmission configuration indicator state and one or more target channels; and communicating one or more transmissions via a first target channel of the one or more target channels prior to transmitting signaling acknowledging the target transmission configuration indicator, wherein communicating the one or more transmissions via the first target channel comprises: communicating the one or more transmissions via the first target channel using the target transmission configuration indicator state when at least one criterion is satisfied, and communicating the one or more transmissions via the first target channel using a default transmission configuration indicator state associated with a default transmission indicator when the at least one criterion is not satisfied.

Clause 2: The method of Clause 1, wherein the at least one criterion comprises a time period between reception of the target transmission configuration indicator and communication of one or more transmissions being greater than a threshold amount of time.

Clause 3: The method of any one of Clauses 1-2, further comprising transmitting capability information indicating whether the UE supports the use of the target transmission configuration indicator state prior to transmitting signaling acknowledging the target transmission configuration indicator.

Clause 4: The method of Clause 3, wherein the at least one criterion comprises the capability information indicating that the UE supports the use of the target transmission configuration indicator state prior to transmitting signaling acknowledging the target transmission configuration indicator.

Clause 5: The method of any one of Clauses 1-4, wherein the default transmission configuration indicator comprises a transmission configuration indicator with a lowest identifier (ID) or a quasi-colocation (QCL) assumption with a lowest ID.

Clause 6: The method of any one of Clauses 1-4, wherein the default transmission configuration indicator comprises a transmission configuration indicator in a transmission configuration indicator codepoint with a lowest identifier (ID).

Clause 7: The method of any one of Clauses 1-6, further comprising receiving the default transmission configuration indicator and transmitting acknowledgement information for the default transmission configuration indicator prior to receiving the target transmission configuration indicator.

Clause 8: The method of any one of Clauses 1-7, further comprising transmitting the signaling acknowledging the reception of the target transmission configuration indicator.

Clause 9: The method of Clause 8, wherein the signaling acknowledging reception of the target transmission configuration indicator further comprises acknowledgement information for the one or more transmissions.

Clause 10: The method of any one of Clauses 1-9, wherein receiving the target transmission configuration indicator comprises receiving the target transmission configuration indicator in a first downlink control information (DCI) message that schedules a first transmission of the one or more transmissions.

Clause 11: The method of Clause 10, further comprising receiving a second DCI message, via a second target channel of the one or more target channels, that schedules a second transmission of the one or more transmissions.

Clause 12: The method of Clause 11, wherein receiving the second DCI message comprises receiving the second DCI message before a threshold amount of time after receiving the target transmission configuration indicator using the default transmission configuration indicator state.

Clause 13: The method of Clause 12, wherein the threshold amount of time comprises a minimum number of symbols needed to configure the UE with the target transmission configuration indicator state.

Clause 14: The method of Clause 11, wherein: receiving the second DCI message comprises receiving the second DCI message after a threshold amount of time after receiving the target transmission configuration indicator using the target transmission configuration indicator state, and the method further comprises communicating the second transmission of the one or more transmissions via the first target channel using the target transmission configuration indicator state.

Clause 15: The method of Clause 14, wherein: the first target channel comprises a physical downlink shared channel (PDSCH) or a physical uplink shared channel (PUSCH), and the second target channel comprises a physical downlink control channel (PDCCH).

Clause 16: The method of Clause 11, wherein communicating one or more transmissions comprises: communicating the first transmission of the one or more transmissions after a threshold amount of time after receiving the target transmission configuration indicator using the target transmission configuration indicator, and communicating the second transmission of the one or more transmissions after the threshold amount of time after receiving the target transmission configuration indicator using the default transmission configuration indicator state.

Clause 17: The method of any one of Clauses 11-16, further comprising transmitting the signaling acknowledging the reception of the target transmission configuration indicator, wherein the signaling further includes acknowledgement information for the first transmission and the second transmission.

Clause 18: A method for wireless communication by a base station (BS), comprising: transmitting a target transmission configuration indicator associated with a target transmission configuration indicator state and one or more target channels; and communicating one or more transmissions via a first target channel of the one or more target channels prior to receiving signaling acknowledging the target transmission configuration indicator, wherein communicating the one or more transmissions via the first target channel comprises: communicating the one or more transmissions via the first target channel using the target transmission configuration indicator state when at least one criterion is satisfied, and communicating the one or more transmissions via the first target channel using a default transmission configuration indicator state associated with a default transmission indicator when the at least one criterion is not satisfied.

Clause 19: The method of Clause 18, wherein the at least one criterion comprises a time period between reception of the target transmission configuration indicator and communication of one or more transmissions being greater than a threshold amount of time.

Clause 20: The method of any one of Clauses 18-19, further comprising receiving capability information indicating whether the UE supports the use of the target transmission configuration indicator state prior to transmitting signaling acknowledging the target transmission configuration indicator.

Clause 21: The method of Clause 20, wherein the at least one criterion comprises the capability information indicating that the UE supports the use of the target transmission configuration indicator state prior to transmitting signaling acknowledging the target transmission configuration indicator.

Clause 22: The method of any one of Clauses 18-21, wherein the default transmission configuration indicator comprises a transmission configuration indicator with a lowest identifier (ID) or a quasi-colocation (QCL) assumption with a lowest ID.

Clause 23: The method of any one of Clauses 18-21, wherein the default transmission configuration indicator comprises a transmission configuration indicator in a transmission configuration indicator codepoint with a lowest identifier (ID).

Clause 24: The method of any one of Clauses 18-23, further comprising transmitting the default transmission configuration indicator and receiving acknowledgement information for the default transmission configuration indicator prior to receiving the target transmission configuration indicator.

Clause 25: The method of any one of Clauses 18-24, further comprising receiving the signaling acknowledging the reception of the target transmission configuration indicator.

Clause 26: The method of Clause 25, wherein the signaling acknowledging reception of the target transmission configuration indicator further comprises acknowledgement information for the one or more transmissions.

Clause 27: The method of any one of Clauses 18-26, wherein transmitting the target transmission configuration indicator comprises transmitting the target transmission configuration indicator in a first downlink control information (DCI) message that schedules a first transmission of the one or more transmissions.

Clause 28: The method of Clause 27, further comprising transmitting a second DCI message, via a second target channel of the one or more target channels, that schedules a second transmission of the one or more transmissions.

Clause 29: The method of Clause 28, wherein transmitting the second DCI message comprises transmitting the second DCI message before a threshold amount of time after receiving the target transmission configuration indicator using the default transmission configuration indicator state.

Clause 30: The method of Clause 29, wherein the threshold amount of time comprises a minimum number of symbols needed to configure the UE with the target transmission configuration indicator state.

Clause 31: The method of Clause 28, wherein: transmitting the second DCI message comprises transmitting the second DCI message after a threshold amount of time after receiving the target transmission configuration indicator using the target transmission configuration indicator state, and the method further comprises communicating the second transmission of the one or more transmissions via the first target channel using the target transmission configuration indicator state.

Clause 32: The method of claim 31, wherein: the first target channel comprises a physical downlink shared channel (PDSCH) or a physical uplink shared channel (PUSCH), and the second target channel comprises a physical downlink control channel (PDCCH).

Clause 33: The method of Clause 28, wherein communicating one or more transmissions comprises: communicating the first transmission of the one or more transmissions after a threshold amount of time after receiving the target transmission configuration indicator using the target transmission configuration indicator, and communicating the second transmission of the one or more transmissions after the threshold amount of time after receiving the target transmission configuration indicator using the default transmission configuration indicator state.

Clause 34: The method of any one of Clauses 28-33, further comprising receiving the signaling acknowledging the reception of the target transmission configuration indicator, wherein the signaling further includes acknowledgement information for the first transmission and the second transmission.

Clause 35: An apparatus, comprising: a memory comprising executable instructions; one or more processors configured to execute the executable instructions and cause the apparatus to perform a method in accordance with any one of Clauses 1-34.

Clause 36: An apparatus, comprising means for performing a method in accordance with any one of Clauses 1-34.

Clause 37: A non-transitory computer-readable medium comprising executable instructions that, when executed by one or more processors of an apparatus, cause the apparatus to perform a method in accordance with any one of Clauses 1-34.

Clause 38: A computer program product embodied on a computer-readable storage medium comprising code for performing a method in accordance with any one of Clauses 1-34.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mm Wave frequencies, the gNB 180 may be referred to as an mm Wave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where Dis DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of communicating using a target TCI state associated with a target TCI prior to acknowledgement of the target TCI in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a user equipment (UE), comprising:
receiving a target transmission configuration indicator associated with a target transmission configuration indicator state and one or more target channels; and
communicating one or more transmissions via a first target channel of the one or more target channels prior to transmitting signaling acknowledging the target transmission configuration indicator, wherein communicating the one or more transmissions via the first target channel comprises:
communicating the one or more transmissions via the first target channel using the target transmission configuration indicator state when at least one criterion is satisfied, and
communicating the one or more transmissions via the first target channel using a default transmission configuration indicator state associated with a default transmission indicator when the at least one criterion is not satisfied.

2. The method of claim 1, wherein the at least one criterion comprises a time period between reception of the target transmission configuration indicator and communication of one or more transmissions being greater than a threshold amount of time.

3. The method of claim 1, further comprising transmitting capability information indicating whether the UE supports the use of the target transmission configuration indicator state prior to transmitting signaling acknowledging the target transmission configuration indicator.

4. The method of claim 3, wherein the at least one criterion comprises the capability information indicating that the UE supports the use of the target transmission configuration indicator state prior to transmitting signaling acknowledging the target transmission configuration indicator.

5. The method of claim 1, wherein the default transmission configuration indicator comprises a transmission configuration indicator with a lowest identifier (ID) or a quasi-colocation (QCL) assumption with a lowest ID.

6. The method of claim 1, wherein the default transmission configuration indicator comprises a transmission configuration indicator in a transmission configuration indicator codepoint with a lowest identifier (ID).

7. The method of claim 1, further comprising receiving the default transmission configuration indicator and transmitting acknowledgement information for the default transmission configuration indicator prior to receiving the target transmission configuration indicator.

8. The method of claim 1, further comprising transmitting the signaling acknowledging the reception of the target transmission configuration indicator.

9. The method of claim 8, wherein the signaling acknowledging reception of the target transmission configuration indicator further comprises acknowledgement information for the one or more transmissions.

10. The method of claim 1, wherein receiving the target transmission configuration indicator comprises receiving the target transmission configuration indicator in a first downlink control information (DCI) message that schedules a first transmission of the one or more transmissions.

11. The method of claim 10, further comprising receiving a second DCI message, via a second target channel of the one or more target channels, that schedules a second transmission of the one or more transmissions.

12. The method of claim 11, wherein receiving the second DCI message comprises receiving the second DCI message before a threshold amount of time after receiving the target transmission configuration indicator using the default transmission configuration indicator state.

13. The method of claim 12, wherein the threshold amount of time comprises a minimum number of symbols needed to configure the UE with the target transmission configuration indicator state.

14. The method of claim 11, wherein:
receiving the second DCI message comprises receiving the second DCI message after a threshold amount of time after receiving the target transmission configuration indicator using the target transmission configuration indicator state, and
the method further comprises communicating the second transmission of the one or more transmissions via the first target channel using the target transmission configuration indicator state.

15. The method of claim 14, wherein:
the first target channel comprises a physical downlink shared channel (PDSCH) or a physical uplink shared channel (PUSCH), and
the second target channel comprises a physical downlink control channel (PDCCH).

16. The method of claim 11, wherein communicating one or more transmissions comprises:
communicating the first transmission of the one or more transmissions after a threshold amount of time after receiving the target transmission configuration indicator using the target transmission configuration indicator, and
communicating the second transmission of the one or more transmissions after the threshold amount of time after receiving the target transmission configuration indicator using the default transmission configuration indicator state.

17. The method of claim 11, further comprising transmitting the signaling acknowledging the reception of the target transmission configuration indicator, wherein the signaling further includes acknowledgement information for the first transmission and the second transmission.

18. A method for wireless communication by a base station (BS), comprising:
transmitting a target transmission configuration indicator associated with a target transmission configuration indicator state and one or more target channels; and
communicating one or more transmissions via a first target channel of the one or more target channels prior to receiving signaling acknowledging the target transmission configuration indicator, wherein communicating the one or more transmissions via the first target channel comprises:
communicating the one or more transmissions via the first target channel using the target transmission configuration indicator state when at least one criterion is satisfied, and
communicating the one or more transmissions via the first target channel using a default transmission configuration indicator state associated with a default transmission indicator when the at least one criterion is not satisfied.

19. The method of claim 18, wherein the at least one criterion comprises a time period between reception of the target transmission configuration indicator and communication of one or more transmissions being greater than a threshold amount of time.

20. The method of claim 18, further comprising receiving capability information indicating whether the UE supports the use of the target transmission configuration indicator state prior to transmitting signaling acknowledging the target transmission configuration indicator, wherein the at least one criterion comprises the capability information indicating that the UE supports the use of the target transmission configuration indicator state prior to transmitting signaling acknowledging the target transmission configuration indicator.

21. The method of claim 18, wherein the default transmission configuration indicator comprises one of:
a transmission configuration indicator with a lowest identifier (ID) or a quasi-colocation (QCL) assumption with a lowest ID; or
a transmission configuration indicator in a transmission configuration indicator codepoint with a lowest identifier (ID).

22. The method of claim 18, further comprising receiving the signaling acknowledging the reception of the target transmission configuration indicator, wherein the signaling acknowledging reception of the target transmission configuration indicator further comprises acknowledgement information for the one or more transmissions.

23. The method of claim 18, wherein transmitting the target transmission configuration indicator comprises transmitting the target transmission configuration indicator in a first downlink control information (DCI) message that schedules a first transmission of the one or more transmissions.

24. The method of claim 23, further comprising transmitting a second DCI message, via a second target channel of the one or more target channels, that schedules a second transmission of the one or more transmissions.

25. The method of claim 24, wherein transmitting the second DCI message comprises transmitting the second DCI message before a threshold amount of time after receiving the target transmission configuration indicator using the default transmission configuration indicator state, wherein the threshold amount of time comprises a minimum number of symbols needed to configure the UE with the target transmission configuration indicator state.

26. The method of claim 24, wherein:
transmitting the second DCI message comprises transmitting the second DCI message after a threshold amount of time after receiving the target transmission configuration indicator using the target transmission configuration indicator state,
the method further comprises communicating the second transmission of the one or more transmissions via the first target channel using the target transmission configuration indicator state,
the first target channel comprises a physical downlink shared channel (PDSCH) or a physical uplink shared channel (PUSCH), and
the second target channel comprises a physical downlink control channel (PDCCH).

27. The method of claim 24, wherein communicating one or more transmissions comprises:
communicating the first transmission of the one or more transmissions after a threshold amount of time after receiving the target transmission configuration indicator using the target transmission configuration indicator, and
communicating the second transmission of the one or more transmissions after the threshold amount of time after receiving the target transmission configuration indicator using the default transmission configuration indicator state.

28. The method of claim 24, further comprising receiving the signaling acknowledging the reception of the target transmission configuration indicator, wherein the signaling further includes acknowledgement information for the first transmission and the second transmission.

29. An apparatus for wireless communication, comprising:
a memory comprising executable instructions; and
one or more processors configured to execute the executable instructions and cause the apparatus to:
receive a target transmission configuration indicator associated with a target transmission configuration indicator state and one or more target channels; and
communicate one or more transmissions via a first target channel of the one or more target channels prior to transmitting signaling acknowledging the target transmission configuration indicator, wherein, in order to communicate the one or more transmissions via the first target channel, the one or more processors are configured to cause the apparatus to:
communicate the one or more transmissions via the first target channel using the target transmission configuration indicator state when at least one criterion is satisfied, and
communicate the one or more transmissions via the first target channel using a default transmission configuration indicator state associated with a default transmission indicator when the at least one criterion is not satisfied.

30. A non-transitory computer-readable medium for wireless communication, comprising:
executable instructions that, when executed by one or more processors of an apparatus, cause the apparatus to
receive a target transmission configuration indicator associated with a target transmission configuration indicator state and one or more target channels; and
communicate one or more transmissions via a first target channel of the one or more target channels prior to transmitting signaling acknowledging the target transmission configuration indicator, wherein, in order to communicate the one or more transmissions via the first target channel, the executable instructions, when executed by the one or more processors of the apparatus, cause the apparatus to:
communicate the one or more transmissions via the first target channel using the target transmission configuration indicator state when at least one criterion is satisfied, and
communicate the one or more transmissions via the first target channel using a default transmission configuration indicator state associated with a default transmission indicator when the at least one criterion is not satisfied.
